(19) United States
(12) Patent Application Publication
(10) Pub. No.: US 2025/0102050 A1
(43) Pub. Date: Mar. 27, 2025

(54) MULTI-SPEED ELECTRIC AXLE

(71) Applicant: Dana Automotive Systems Group, LLC, Maumee, OH (US)

(72) Inventor: Eric M. ENGERMAN, Plymouth, MI (US)

(21) Appl. No.: 18/828,899

(22) Filed: Sep. 9, 2024

Related U.S. Application Data
(60) Provisional application No. 63/584,787, filed on Sep. 22, 2023.

(51) Int. Cl. F16H 37/08; F16H 3/44; F16H 63/34

(52) U.S. Cl. CPC F16H 37/082; F16H 3/44; F16H 63/3416; F16H 2200/0021; F16H 2200/0034; F16H 2200/2005; F16H 2200/2094

(57) ABSTRACT

A system and method for a multi-speed electric axle. The multi-speed electric axle includes, in one example, an electric machine rotationally coupled an input shaft and a planetary gear set that includes a ring gear rotationally coupled to the input shaft or an output shaft and a carrier or the ring gear rotationally coupled to the input shaft or the output shaft. The multi-speed electric axle further includes one or more clutches configured to selectively ground a sun gear or a carrier in the planetary gear set and configured to selectively rotationally couple the sun gear and the carrier.

### CROSS-REFERENCE TO RELATED APPLICATION

The present application claims priority to U.S. Provisional Application No. 63/584,787, entitled “MULTI-SPEED ELECTRIC AXLE”, and filed on Sep. 22, 2023. The entire contents of the above-listed application are hereby incorporated by reference for all purposes.

### TECHNICAL FIELD

The present disclosure relates to a multi-speed electric axle with a space efficient architecture.

### BACKGROUND AND SUMMARY

Segments of the vehicle market are moving towards electrification. Certain vehicle platforms demand off-road and on-road capabilities. Certain off-road capable vehicles demand comparatively large gear reductions to achieve high torque while achieving high system efficiency. Further, some electric vehicles (EVs) have exhibited issues in achieving target gear ratios for off-road vehicle travel in a compact package while maintaining desired system stiffness for on-road noise, vibration, and harshness (NVH) and robust clutch arrangements.

The inventors have recognized the abovementioned challenges and developed a multi-speed electric axle assembly to at least partially overcome the challenges. The electric axle assembly includes, in one example, a multi-speed electric axle assembly. The multi-speed electric axle, in one example, includes an electric machine rotationally coupled an input shaft and a planetary gear set. In such an example, the planetary gear set includes a ring gear rotationally coupled to the input shaft or an output shaft. The planetary gear set further includes a carrier or the ring gear rotationally coupled to the input shaft or the output shaft. The electric axle assembly even further includes one or more clutches configured to selectively ground a sun gear or a carrier in the planetary gear set and rotationally couple the sun gear and the carrier. In this way, the electric axle achieves operating gear ratios for operating the EV in both off-road and on-road environments while maintaining axle stiffness goals which allow the vehicle to be operated in on-road environments with comparatively low NVH and in a comparatively compact package.

In one example, the ring gear may be rotationally coupled to the input shaft, the carrier may be rotationally coupled to the output shaft and the one or more clutches are configured to ground the sun gear. In such an example, the planetary gear set may be a simple planetary gear set. In this way, the electric axle assembly is able to achieve a comparatively lower gear ratio spread (e.g., a gear ratio spread of less than 1.6, in one use-case example) between the operating gears that are achieved via engagement of the two clutches. Consequently, the electric axle's shifting performance is tuned for certain vehicle platforms.

In an alternate example, the ring gear may be rotationally coupled to the output shaft, the sun gear may be rotationally coupled to the input shaft, and the one or more clutches are configured to selectively grounds the carrier. In such an example, the planetary gear set may be a meshed planet compound planetary gear set. In this way, the electric axle assembly is able to achieve a comparatively higher gear ratio spread (e.g., a gear ratio spread of greater than 1.8, in one use-case example) between the operating gears that are achieved via engagement of the two clutches. Consequently, the electric axle assembly shifting performance is tuned for alternate vehicle platforms, thereby increasing customer appeal.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 shows a schematic depiction of a first example of an electric axle in a vehicle.

FIGS. 2A and 2B show clutch configurations in a planetary gear set of the electric axle depicted in FIG. 1.

FIG. 3 shows a second example of an electric axle.

FIGS. 4A and 4B show clutch configurations in a planetary gear set of the electric axle depicted in FIG. 3.

FIGS. 5-6 show different views of a detailed example of an electric axle.

FIGS. 7-8 show power paths through the electric axle depicted in FIG. 5 in different gear modes.

FIGS. 9-10 show other views of the electric axle depicted in FIG. 5.

### DETAILED DESCRIPTION

Electric axles are described herein that achieve increased efficiency and on-road and off-road powertrain performance targets. To elaborate, in one example, a multi-speed (e.g., two-speed) electric axle with a highly efficient parallel axis geartrain, is provided, that can shift either on stop, shift on the fly with power off, or with added hardware, powershift a planetary gear set from a lower ratio stage with reduced meshing and bearing losses (e.g., a 1:1 gear ratio stage, in one use-case example) to a stage with a higher ratio (e.g., a planetary ratio less than 1.6, in one example or greater than 1.8, in another example). In this way, the system achieves a desired gear ratio range between the higher and lower speed modes in an axle package that has a desired amount of stiffness for on-road acceptable noise, vibration, and harshness (NVH), for instance while maintaining robust clutch arrangements.

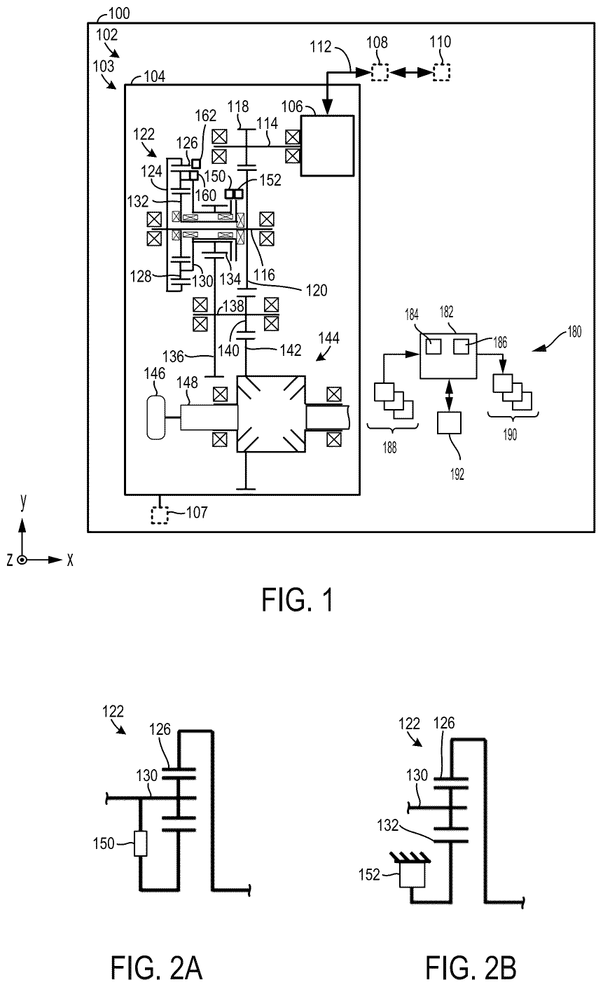

FIG. 1 shows an electric vehicle (EV) 100 that includes a powertrain 102 with an electric axle assembly 103 with an electric axle 104 (e.g., a front electric axle) which may be formed as an assembly. The EV 100 may be a hybrid EV in one example, or an all-electric vehicle (e.g., battery electric vehicle (BEV)) in another example.

As described herein an electric axle is an electric drive incorporated into an axle. The electric axle may be an electric beam axle, in one example. A beam axle is an axle with mechanical components structurally supporting one another and extending between drive wheels. For instance, the beam axle may be a structurally continuous structure that spans the drive wheels on a lateral axis, in one embodiment. Thus, wheels coupled to the beam axle substantially move in unison when articulating, during, for example, vehicle travel on uneven road surfaces. To elaborate, the camber angle of the wheels may remain substantially constant as the suspension moves through its travel. The beam axle may be coupled to a dependent suspension system 107, in one example. Therefore, the electric axle may be an unsprung mass.

The electric axle 104 includes an electric machine 106 (e.g., a traction motor). The electric machine 106 may be an electric motor-generator, for example. For instance, the electric machine 106 may be designed as a multi-phase alternating current (AC) motor-generator. However, in other examples, the electric machine may be a motor without generator capabilities.

As illustrated in FIG. 1, the electric machine 106 may be electrically coupled to an inverter 108. The inverter 108 is designed to convert direct current (DC) electric power to alternating current (AC) electric power and vice versa. Therefore, the electric machine 106 may be an AC electric machine, as previously indicated. However, in other examples, the electric machine may be a DC electric machine and the inverter may therefore be omitted from the electric drive, in such an example. The inverter 108 may receive electric energy from one or more energy storage device(s) 110 (e.g., traction batteries, capacitors, combinations thereof, and the like). Arrows 112 signify the electric energy transfer between the electric machine 106, the inverter 108, and the energy storage device(s) 110 that may occur during different modes of electric axle operation (e.g., a drive mode and a regeneration mode). As such, during a drive mode, electric energy may flow from the energy storage device(s) 110 to the electric machine 106 and during a regenerative mode, electric energy may flow in the opposite direction from the electric machine to the energy storage device(s).

The electric axle 104 further includes an input shaft 114 and an intermediate shaft 116. A gear 118 fixedly coupled or incorporated in the input shaft 114 meshes with a gear 120, in the illustrated example. The gear 120 is fixedly coupled or incorporated into the intermediate shaft 116, in the illustrated example. Further, the intermediate shaft 116 is rotationally coupled to a planetary gear set 122 via a component 124. To expound, a ring gear 126 in the planetary gear set 122 is coupled to the intermediate shaft 116 via the component 124. The planetary gear set 122 is a simple planetary gear set in the illustrated example. However, other types of planetary gear sets may be used in the electric axle in other examples. For instance, as expanded upon herein, the electric axle may include a planetary gear set with multiple sets of planet gears such as a meshed planet compound planetary gear set. The planetary gear set 122 is arranged coaxial to the intermediate shaft 116, in the illustrated example, to increase axle compactness.

The planetary gear set 122 further includes planet gears 128 that rotate on a carrier 130 and mesh with the ring gear 126 and a sun gear 132. The carrier 130 is rotationally coupled to a gear 134 which meshes with a gear 136 that is rotationally coupled to an output shaft 138. A gear 140 is rotationally coupled to the output shaft 138 and meshes with an input gear 142 for a differential 144, in the illustrated example. In turn, the differential 144 is rotationally coupled to drive wheels 146 via axle shafts 148 (e.g., half shafts).

A clutch 150 is configured to connect the carrier 130 to the intermediate shaft 116 when engaged. Another clutch 152 is configured to ground the sun gear 132, when engaged. The clutches 150 and 152 may be inversely engaged and disengaged to operate the geartrain in different gear modes. To elaborate, the clutch 150 is engaged and the clutch 152 is disengaged in a higher speed mode. In another example, the functions of the clutches may be incorporated into a single clutch. For instance, one clutch may be configured to ground the sun gear 132 in one mode and rotationally coupled the carrier 130 and the sun gear 132 in another mode. Further, in such an example, the clutch may be configured to operate in a neutral mode.

FIG. 2A shows the configuration of the planetary gear set 122 in this higher speed mode where the clutch 150 is engaged (and the clutch 152 is disengaged). As shown, the carrier 130 functions as an output and the ring gear 126 functions as the input. In such an example, the planetary gear set ratio is 1:1. Further, in the higher speed mode all of the gears and components in the planetary gear set rotate in unison. Therefore, in the higher speed mode, the planetary gear set experiences reduced (e.g., substantially avoids) bearing or meshing losses. In this way, electric axle efficiency and longevity is increased. Conversely, the clutch 150 is disengaged and the clutch 152 is engaged in a lower speed mode.

FIG. 2B shows the configuration of the planetary gear set 122 in this lower speed mode. As shown, the carrier 130 functions as an output and the ring gear 126 functions as the input. In such an example, the planetary gear set ratio is determined by the following equation: (Ring gear size+Sun gear size)/(Ring gear size). In this way, the electric axle 104 is designed for both lower speed and higher speed operation which allows the vehicle to be utilized in a wider variety of environments such as on-road and off-road environments, for instance. In one use-case example, in the lower speed mode, the first gear ratio may be between 15.6-37:1. In such an example, the ratio between the gears 118 and 120 may be 3.323. Further, in such an example, the planetary gear set ratio is 1:1 in the lower speed mode. Further, the ratio between the gears 134 and 136 may be 2.027 and the ratio between the gears 140 and 142 may be 2.677. Conversely, in the higher speed operating mode the second gear ratio may be between 12-20:1. In such an example, the ratio of the planetary gear set may be 1.54:1. More generally, the gear ratio spread between the first and second gear ratios may be less than 1.6 to allow the vehicle to be used in a wider variety of operating environments. It will be understood that the different gear ratios in the geartrain may be selected based on the end-use vehicle platform demands. Further, in FIGS. 2A and 2B, the carrier 130 functions as the input of the planetary gear set 122 and the ring gear 126 functions as the output of the planetary gear set 122 when the electric axle is operating in a drive mode.

In the electric axle 104 a park gear 160 may be coupled to the carrier 130 and a park device 162 is configured to selectively engage the park gear. In this way, the electric axle may space efficiently incorporate parking brake functionality.

The EV 100 may also include a control system 180 with a controller 182. The controller 182 includes a processor 184 and memory 186. The memory 186 holds instructions stored therein that when executed by the processor 184 cause the controller 182 to perform the various methods, control techniques, etc., described herein. The processor 184 may include a microprocessor unit and/or other types of circuits. The memory 186 includes known data storage mediums such as random access memory, read only memory, keep alive memory, combinations thereof, and the like.

The controller 182 may receive various signals from sensors 188 positioned in different locations in the EV 100 and the electric axle 104, more specifically. The sensors may include an electric machine speed sensor, clutch position sensors, energy storage device temperature sensor(s), an energy storage device state of charge sensor(s), wheel speed sensors, and the like. The controller 182 may also send control signals to various actuators 190 coupled at different locations in the EV 100, and the electric axle 104. For instance, the controller 182 may send signals to the inverter 108 to adjust the rotational speed of the electric machine 106. The other controllable components in the vehicle and powertrain may function in a similar manner with regard to command signals and actuator adjustment. For instance, the controller 182 may send signals to the clutches 150 and 152 to engage and disengage the clutches to operate the axle in different range modes, which are expanded upon herein. The controller and control system shown in FIG. 1 may be used in the other electric axle examples described herein.

The EV 100 may also include one or more input device(s) 192 (e.g., an accelerator pedal, a brake pedal, a gear selector, a differential locker actuator, a console instrument panel, a touch interface, a touch panel, a keyboard, combinations thereof, and the like) in electronic communication with the controller 182. The input device(s) 192, responsive to operator input, may generate an acceleration adjustment request, a gear shift request, and the like.

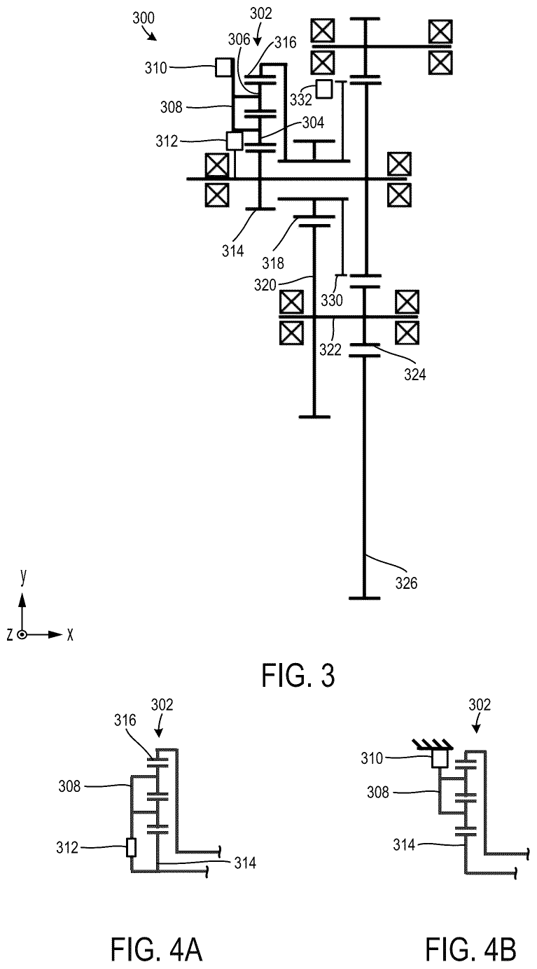

An axis system is provided in FIG. 1 as well as FIGS. 3 and 5-10, for reference, when appropriate. The z-axis may be a vertical axis (e.g., parallel to a gravitational axis), the x-axis may be a lateral axis (e.g., horizontal axis), and/or the y-axis may be a longitudinal axis, in one example. However, the axes may have other orientations, in other examples.

The electric axle 104 and the other electric axles described herein may implement a power shifting control strategy where one clutch is disengaged while the other clutch is engaged to reduce torque interruptions. A power shifting system is highly efficient in road operations since it results in zero meshing losses in the two-speed planetary gear set and reduces bearing losses substantially.

FIG. 3 shows another example of an electric axle 300. The electric axle 300 includes at least some overlapping components with the electric axle 104, shown in FIG. 1 and redundant description of these components is omitted for brevity and similar components are similarly numbered.

FIG. 3 specifically shows a planetary gear set 302 with a first set of planet gears 304 and a second set of planet gears 306 which both rotate on a carrier 308. The planet gears 304 mesh with the planet gears 306, in the illustrated example. As such, the planetary gear set 302 is a meshed planet compound planetary gear set, in the illustrated example. However, other suitable types of planetary gear sets may be used in alternate examples.

As shown in FIG. 3, a clutch 310 is configured to ground the carrier 308 and a clutch 312 is configured to rotationally couple the carrier 308 to a sun gear 314. In other examples, a single clutch may be designed to provide the two aforementioned functions.

Further, the planetary gear set 302 includes a ring gear 316 that is rotationally coupled to a gear 318 which meshes with a gear 320 on an output shaft 322 which includes another gear 324 which meshes with an input gear 326 in a differential. A park gear 330 is fixedly coupled to a shaft on which the gear 318 rotates. The park gear 330 may be engaged via a park mechanism 332.

FIG. 4A shows the configuration of the planetary gear set 302 in a higher speed mode where the clutch 312 is engaged (and the clutch 310 is disengaged, shown in FIG. 3). As shown, the ring gear 316 functions as an output and the sun gear 314 functions as the input. In such an example, the planetary gear set ratio is 1:1. Further, in the higher speed mode all of the gears and components in the planetary gear set rotate in unison. Therefore, in the higher speed mode, the planetary gear set experiences reduced (e.g., substantially avoids) bearing or meshing losses. In this way, electric axle efficiency and longevity is increased. Conversely, the clutch 312 is disengaged and the clutch 310 is engaged in a lower speed mode.

FIG. 4B shows the configuration of the planetary gear set 302 in the lower speed mode. As shown, the ring gear 316 functions as an output and the sun gear 314 functions as the input. Further, the clutch 310 grounds the carrier 308. In such an example, the planetary gear set ratio is determined by the following equation: (Ring gear size)/(Sun gear size). In the electric axle 300, the first gear ratio in the lower speed mode may be between 21.3-44:1 and the second gear ratio in the higher speed mode may be between 12-20:1. More generally, in one example, the ratio spread between the lower and higher speed operating modes may be greater than 1.8. In this way, the electric axle may fulfill performance demands of some vehicle platforms. It will be understood that the different gear ratios in the geartrain may be selected based on the end-use vehicle platform demands.

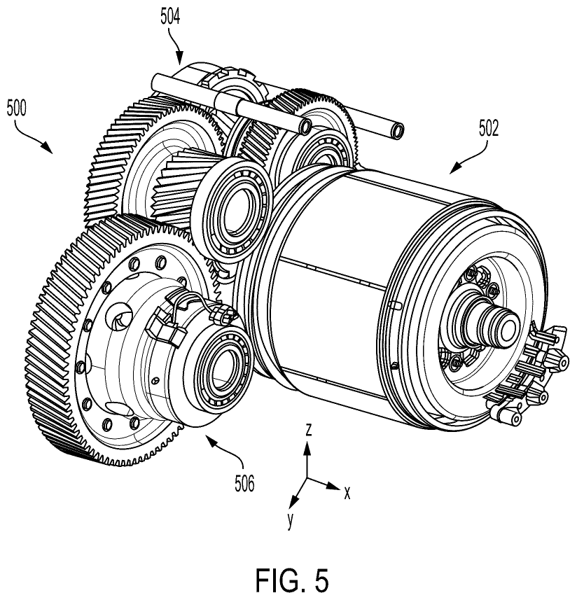

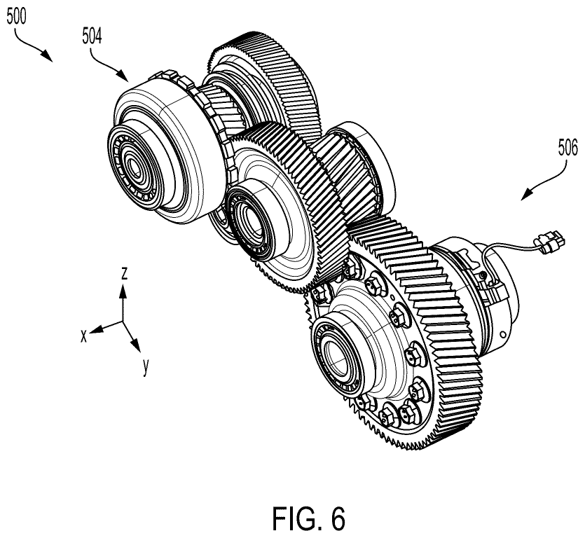

FIG. 5 shows a detailed example of an electric axle 500 with the component architecture depicted in FIG. 1. The electric axle 500 again includes an electric machine 502, a planetary gear set 504 with two clutches, and a differential 506. FIG. 6 shows the electric axle 500 with the electric motor omitted, to reveal additional details of the planetary gear set 504.

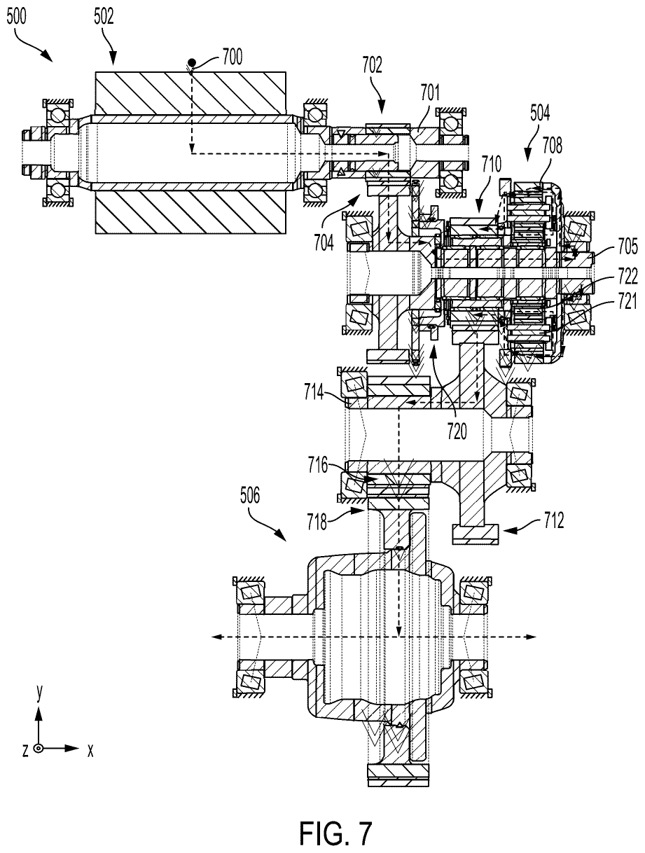

FIG. 7 shows a mechanical power path 700 through the electric axle 500 in the higher range mode. As shown, power travels from the electric machine 502 to an input shaft 701, from the input shaft to a gear 702, from the gear 702 to a gear 704 that is coupled to or formed with an intermediate shaft 705, from the intermediate shaft 705 to a ring gear 708 in the planetary gear set 504, from the ring gear 708 to a gear 710, from the gear 710 to a gear 712 coupled to an output shaft 714, and from the output shaft 714 to a gear 716, from the gear 716 to the differential 506 by way of a gear 718. It will be understood that in the planetary gear set 504 power flows through a ring gear 708 to the gear 710 which is idly coupled to the intermediate shaft 705. FIG. 7 further shows a clutch 720 that may be configured to rotationally couple a carrier 721 and a sun gear 722, in the axle configuration shown in FIG. 7. The clutch 720 or another clutch may be configured to ground the sun gear 722. However, in other examples two clutches may provide the two aforementioned functions.

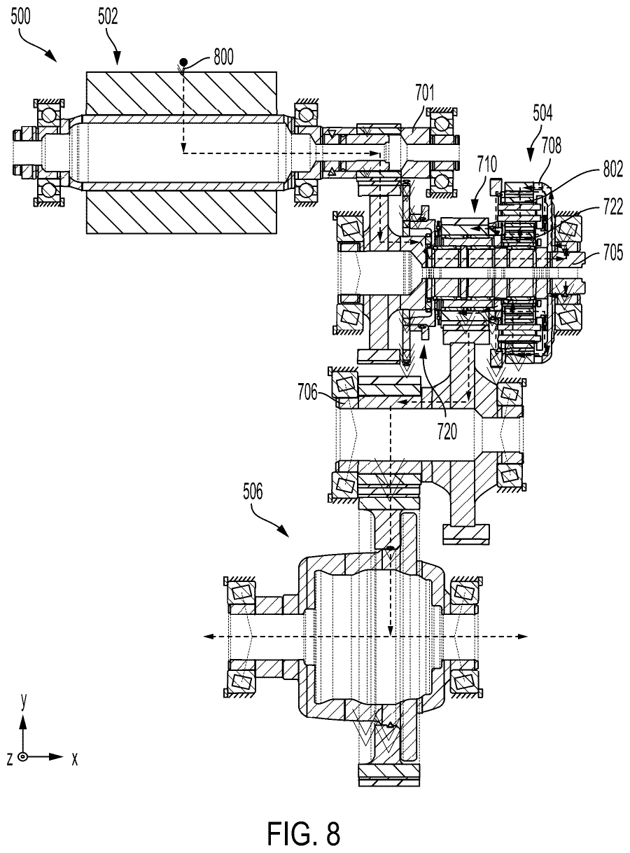

FIG. 8 shows a mechanical power path 800 through the electric axle 500 in the lower range mode where the sun gear 722 is grounded. As shown, power travels from the electric machine 502 to an input shaft 701, from the input shaft to the planetary gear set 504 via the intermediate shaft 705, from the planetary gear set to the output shaft 706, and from the output shaft to the differential 506. In the planetary gear set 504 power flows through the ring gear 708, planet gears 802, and sun gear 722 to the gear 710 which is idly coupled to the intermediate shaft 705.

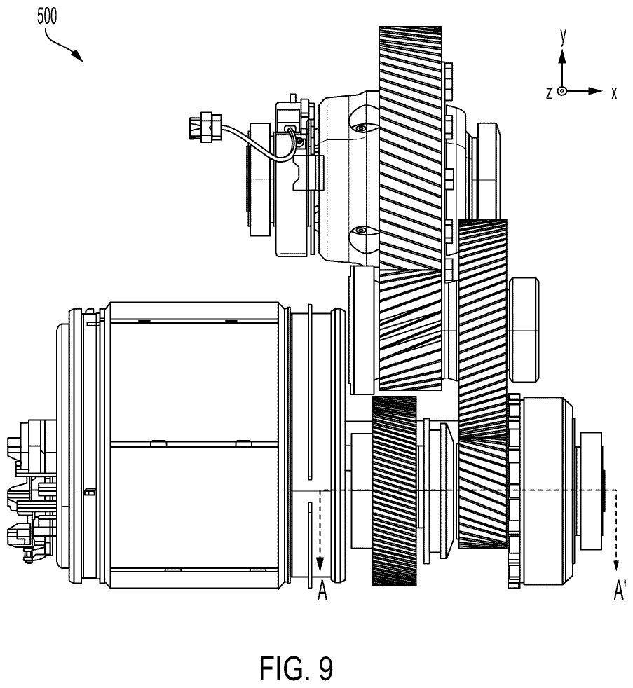

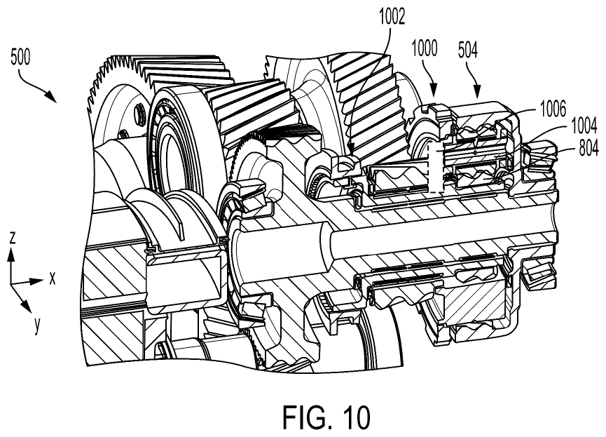

FIG. 9 shows another view of the electric axle 500. Cutting plane A-A′ indicates the cross-sectional view depicted in FIG. 10. FIG. 10 shows the planetary gear set 504 with a parking gear 1000 coupled thereto. Further, a clutch 1002 which rotationally couples a carrier 1004 and the sun gear 804 when engaged is illustrated in FIG. 10. Further, a clutch 1006, schematically depicted in FIG. 10, is configured to ground the carrier 1004 when engaged.

The electric axles described herein achieve a highly efficient parallel axis geartrain for on-road and off-road capabilities that is able to shift either on stop, shift on the fly with the power off, or powershift the planetary gear set between a higher range mode with a decreased amount of meshing and bearing losses in the planetary gear set to a lower range mode that may be suitable for operating the vehicle in an off-road environment for instance.

FIGS. 5-10 are drawn approximately to scale, aside from the schematically depicted components. However, the components may have alternate relative dimensions, in other embodiments.

FIGS. 1-10 show example configurations with relative positioning of the various components. However, it will be appreciated that if shown directly contacting each other, or directly coupled, then such elements may be referred to as directly contacting or directly coupled, respectively, at least in one example. Similarly, elements shown contiguous or adjacent to one another may be referred to as contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Additionally, elements co-axial with one another may be referred to as such, in one example. Further, elements shown intersecting one another may be referred to as intersecting elements or intersecting one another, in at least one example. Further still, an element shown within another element or shown outside of another element may be referred as such, in one example. In other examples, elements offset from one another may be referred to as such. Still further in some examples, elements positioned coaxial or parallel to one another may be referred to as such.

The invention will be further described in the following paragraphs. In one aspect, a multi-speed electric axle assembly is provided that comprises an electric machine rotationally coupled an input shaft; a planetary gear set including: a ring gear rotationally coupled to the input shaft or an output shaft; and a carrier or the ring gear rotationally coupled to the input shaft or the output shaft; one or more clutches configured to selectively ground a sun gear or a carrier in the planetary gear set; and selectively rotationally couple the sun gear and the carrier. In one example, the multi-speed electric axle assembly may be a front multi-speed electric axle assembly. In another example, the ring gear may be rotationally coupled to the input shaft; the carrier may be rotationally coupled to the output shaft; and the one or more clutches may be configured to selectively ground the sun gear. In another example, the planetary gear set may be a simple planetary gear set. In another example, the ring gear may be rotationally coupled to the output shaft; the sun gear may be rotationally coupled to the input shaft; and the one or more clutches may be configured to selectively ground the carrier. In another example, the planetary gear set may be a meshed planet compound planetary gear set. In such an example, the one or more clutches may be a dog clutch. In one example, wherein planetary gear set may be positioned coaxial to an intermediate shaft. In yet another example, the output shaft may be coupled to a differential via a third gear that meshes with an input gear in the differential. In yet another example, the electric axle assembly may further comprise a park gear that is rotationally coupled to the ring gear. In one example, the multi-speed electric axle assembly further comprises a park gear that is rotationally coupled to the carrier.

In another aspect, a multi-speed electric beam axle is provided that comprises a traction motor rotationally coupled an input shaft; a meshed planet compound planetary gear set or a simple planetary gear set including: a ring gear, a carrier, and a sun gear; one or more clutches configured to selectively ground the sun gear or the carrier in the planetary gear set; and selectively rotationally couple the sun gear and the carrier. In example, the planetary gear set may be the simple planetary gear set; the ring gear may be rotationally coupled to the input shaft; the carrier may be rotationally coupled to the output shaft; and the one or more clutches may be configured to selectively ground the sun gear. In one example, the multi-speed electric beam axle may further comprise a park gear that is rotationally coupled to the ring gear. In one example, a gear ratio spread of the simple planetary gear set may be less than 1.6:1. In another example, the planetary gear set may be the meshed planet compound planetary gear set; the ring gear may be rotationally coupled to the output shaft; the sun gear may be rotationally coupled to the input shaft; and the one or more clutches may be configured to selectively ground the carrier. In another example, the multi-speed electric beam axle may further comprise a park gear that is rotationally coupled to the carrier. In another example, the multi-speed electric axle assembly may be a front multi-speed electric axle assembly. In another example, the one or more clutches may be a dog clutch. In another example, the planetary gear set is positioned coaxial to an intermediate shaft.

Note that the example control and estimation routines included herein can be used with various powertrain, transmission, and/or vehicle system configurations. The control methods and routines disclosed herein may be stored as executable instructions in non-transitory memory and may be carried out by the control system including the controller in combination with the various sensors, actuators, and other vehicle hardware. Further, the described actions, operations and/or functions may graphically represent code to be programmed into non-transitory memory of the computer readable storage medium in the vehicle control, where the described actions are carried out by executing the instructions in a system including the various hardware components in combination with the electronic controller. One or more of the method steps described herein may be omitted if desired.

While various embodiments have been described above, it should be understood that they have been presented by way of example, and not limitation. It will be apparent to persons skilled in the relevant arts that the disclosed subject matter may be embodied in other specific forms without departing from the spirit of the subject matter. The embodiments described above are therefore to be considered in all respects as illustrative, not restrictive. As such, these specific examples are not to be considered in a limiting sense, because numerous variations are possible. For example, the above technology can be applied to powertrains that include different types of propulsion sources including different types of electric machines and engines (e.g., internal combustion engines). The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A multi-speed electric axle assembly, comprising:
an electric machine rotationally coupled an input shaft;
a planetary gear set including:
a ring gear rotationally coupled to the input shaft or an output shaft; and
a carrier or the ring gear rotationally coupled to the input shaft or the output shaft;
one or more clutches configured to:
selectively ground a sun gear or the carrier in the planetary gear set; and
selectively rotationally couple the sun gear and the carrier.

2. The multi-speed electric axle assembly of claim 1, wherein the multi-speed electric axle assembly is a front multi-speed electric axle assembly.

3. The multi-speed electric axle assembly of claim 1, wherein:
the ring gear is rotationally coupled to the input shaft;
the carrier is rotationally coupled to the output shaft; and
the one or more clutches are configured to selectively ground the sun gear.

4. The multi-speed electric axle assembly of claim 3, wherein the planetary gear set is a simple planetary gear set.

5. The multi-speed electric axle assembly of claim 1, wherein:
the ring gear is rotationally coupled to the output shaft;
the sun gear is rotationally coupled to the input shaft; and
the one or more clutches are configured to selectively ground the carrier.

6. The multi-speed electric axle assembly of claim 5, wherein the planetary gear set is a meshed planet compound planetary gear set.

7. The multi-speed electric axle assembly of claim 1, wherein the one or more clutches are dog clutch(es).

8. The multi-speed electric axle assembly of claim 7, wherein the planetary gear set is positioned coaxial to an intermediate shaft.

9. The multi-speed electric axle assembly of claim 1, wherein the output shaft is coupled to a differential via a third gear that meshes with an input gear in the differential.

10. The multi-speed electric axle assembly of claim 1, further comprising a park gear that is rotationally coupled to the ring gear.

11. The multi-speed electric axle assembly of claim 1, further comprising a park gear that is rotationally coupled to the carrier.

12. A multi-speed electric beam axle, comprising:
a traction motor rotationally coupled an input shaft;
a meshed planet compound planetary gear set or a simple planetary gear set including:
a ring gear, a carrier, and a sun gear;
one or more clutches configured to:
selectively ground the sun gear or the carrier in the planetary gear set; and
selectively rotationally couple the sun gear and the carrier.

13. The multi-speed electric beam axle of claim 12, wherein:
the planetary gear set is the simple planetary gear set;
the ring gear is rotationally coupled to the input shaft;
the carrier is rotationally coupled to an output shaft; and
the one or more clutches are configured to selectively ground the sun gear.

14. The multi-speed electric beam axle of claim 13, further comprising a park gear that is rotationally coupled to the ring gear.

15. The multi-speed electric beam axle of claim 13, wherein a gear ratio spread of the simple planetary gear set is less than 1.6:1.

16. The multi-speed electric beam axle of claim 12, wherein:
the planetary gear set is the meshed planet compound planetary gear set;
the ring gear is rotationally coupled to an output shaft;
the sun gear is rotationally coupled to the input shaft; and
the one or more clutches are configured to selectively ground the carrier.

17. The multi-speed electric beam axle of claim 16, further comprising a park gear that is rotationally coupled to the carrier.

18. The multi-speed electric beam axle of claim 16, wherein the multi-speed electric beam axle is a front multi-speed electric axle assembly.

19. The multi-speed electric beam axle of claim 12, wherein the one are more clutches are dog clutch(es).

20. The multi-speed electric beam axle of claim 12, wherein the planetary gear set is positioned coaxial to an intermediate shaft.
